(19) United States
(12) Patent Application Publication
(10) Pub. No.: US 2015/0188993 A1
(43) Pub. Date: Jul. 2, 2015

(54) SYSTEM AND METHOD OF STORING AND DISTRIBUTING DATA

(71) Applicant: Mark Dibner, Research Triangle Park, NC (US)

(72) Inventor: Mark Dibner, Research Triangle Park, NC (US)

(21) Appl. No.: 14/402,563

(22) PCT Filed: May 30, 2013
(86) PCT No.: PCT/US13/43286

§ 371 Date: Nov. 20, 2014

Related U.S. Application Data
(60) Provisional application No. 61/689,219, filed on Jun. 1, 2012.

(51) Int. Cl. H04L 29/08; G06F 3/0484

(52) U.S. Cl. CPC H04L 67/10; G06F 3/04842

(57) ABSTRACT

A system and method for the upload, storage, and distribution of information. In particular, the embodiments are directed to systems and methods for uploading, storing, managing and distributing personal information. The system includes an interface where a user inputs personal information, identifies one or more recipients of such information, designates a time for distributing such information to the recipient upon the occurrence of an event, namely the death or incapacitation of the user. The user designates one or more individuals to confirm the occurrence of an event to the computer system which triggers the distribution of user's information in accordance with user's prepared instructions.

The embodiments of the present invention relate to a system and method of inputting, storing and distributing information. In particular, the embodiments describe the input and storage of personal information on a computer system, and the management and dissemination of the same upon the occurrence of an event.

### SUMMARY OF THE INVENTION

One embodiment of the invention provides for a method of uploading, storing, and distributing information, including the steps of providing a computer interface, for a user to upload information onto a computer readable medium, providing a link between the computer interface and a data storage system, the data storage system housing the user's uploaded information stored on computer readable medium, providing a processing device that executes instructions to the user to identify a person, who will upload information via the computer interface upon the occurrence of an event, providing a processing device that executes instructions to the user to identify a recipient of user's uploaded information upon the occurrence of the event, providing a processing device that executes instructions to the user to select a time period for the retrieval and distribution of user's information, enabling the user identified person to interact with the computer interface, to provide notice to the processing device that the event has occurred, and enabling the processing device to retrieve and distribute user's information to user identified recipients in accordance with the time period preselected by the user.

A further embodiment of the invention provides for a system for uploading, storing and distributing information including an interface that enables a user to upload information onto a computer readable medium, a database to store user uploaded information and a computing device. The computing device executes commands to instruct user to upload user information, to identify at least one person to notify the computing device of the occurrence of an event, to identify at least one recipient to receive user information upon the occurrence of the event, to select a time period for the retrieval and distribution of user information to one or more user identified recipients upon the occurrence of the event, enable the user identified person to notify the computing device when the event has occurred, and retrieve and distribute user information to user identified recipients in accordance with the time periods preselected by the user.

As will be appreciated by those skilled in the art, various alternative embodiments are envisioned. Various uses, objects, advantages and features will become more apparent to those skilled in the art by examination of the detailed description that follows.

### BRIEF DESCRIPTION OF THE DRAWINGS

FIG. 1 is an exemplary flow diagram of the preferred embodiments described herein.

### DESCRIPTION

With the use of computers and digital storage media becoming accessible to all people, it has become attractive for individuals to input and store personal information on a computer system. These computer systems are typically located remotely and are commonly referred to as “cloud computing.” Significant amounts of information may be stored in such cloud computing systems. This is an attractive way for individuals and businesses to store information without having to purchase large digital storage capacity. In addition, cloud computing storage systems offer the advantage of storing information off site to the user so that in the event of a fire or flood or other natural disaster, the user's digitally stored information will not be compromised.

Increasingly more people of all ages are becoming adept to operating computers and using digital methods to store and manage their personal information. People are wanting to manage their own information, including financial, banking, personal information, address and contact information and the like. This may include planning for the distribution of their assets and estate when they die. Typically that involves working with an attorney to create estate documents that reflect the person's wishes regarding these matters.

With regard to an individual's estate information, some information may be stored in a home office or on a home computer. This may typically include banking and investment information. But the identity of the user's estate attorney may not be easily found nor might be the identity of the user's insurance professional(s), or the locations of specific assets. More often than not, by the time a person dies, their spouse or children are left to try to find all the necessary information needed to wrap up the user's affairs. This includes all the estate law issues (such as identifying all property and the rightful recipient(s)) as well as closing down accounts (both locally, such as a gym membership, and digitally, such as a Facebook account). Sometimes such a chore is straightforward when all the information is provided. But too often families of someone who has died have had to dig through a mass of documentation to sometimes find the information they are seeking and sometimes to never find it at all. As a result, many wishes of an individual are left unresolved and many issues remain following the individual's death. Resolution of such issues can take weeks or months and often requires significant time and effort spent by the family and friends of the deceased. This outcome can provide a significant sense of unease for the family and friends of the deceased for months and years to come.

A further example may include making arrangements for the care of a beloved pet in the event of a person's death or incapacitation. It is often the case that when a person dies or becomes incapacitated, a pet may become neglected simply because no one knew of its existence for a few days or those in charge of caring for the user cannot or will not take care of a pet formerly belonging to the deceased.

The embodiments described herein enable a person to digitally input, store and manage all information relevant to his or her estate and personal life on a computing system. In addition the described embodiments provide a way for a person to designate certain individuals who will notify the computing system of that person's death or incapacitation which will prompt the controlled release of all of that person's personal and estate information to individuals previously identified by that person. Finally, the embodiments herein provide a person with the ability to direct who will receive certain personal information as well as when such information will be released following that person's death or incapacitation. It is understood that the embodiments described herein are exemplary in nature and are not intended to in any way limit the scope of the invention described herein.

Input of Information

The input of personal information begins with a person's use of a computer interface. This may be an interactive website accessed by the person's personal computer, laptop, tablet device, smart phone or the like. Once the person (hereafter referred to as the “User”) has access to the interface, the User is then given access to a series of questions, prompts and lists that are designed to enable the User to capture all of the User's personal and estate information. “Access” to the interface may be obtained by the payment of a fee, confirmation of membership in a designated organization, confirmation of employment by a designated corporation, or the confirmation of information provided to the computer. Moreover, it is understood that access may be available to all users of the interface.

The information is uploaded by a User and stored on a computer readable medium held within a computer system database. This can include the computer storage database located on a personal computer, or it may be located remotely in a cloud computing system.

The information provided to the computer system includes, but would not be limited to, financial, banking, savings, legal, and contact information. This information may also include the identification of trust accounts, investment accounts, and/or the User's interest in real and personal property. This information may also include funeral information and instructions relating to burial and the disposition of the User's body, related notifications and contacts, as well as obituary information. This information may include instructions for the desired disposition of homes, personal property and pets. The information may also include the identification of any religious and other organizational affiliations. The information may include loans owed or due, payment instructions, and instructions for access to secured or hidden items and property. The information may include the identification and disposition of personal access to other websites, including the usernames and passwords. The information may include business information and instructions regarding the disposition or continuation of any business or corporate activity with which the User was involved. The information may include the identification of any digital copies of certain photographs or other documents, any personal messages to be sent following the death or incapacitation of the User and the identification or the existence of any wills, trusts and other estate wishes, as well as the identity of the User's estate attorney(s).

It should be noted that in addition to information, the computer system interface will allow the User to electronically upload documentation and store it in electronic form in the User's file. This may include copies of wills, trusts, photographs and any other valuable, legal or personal documentation. This information is not always gathered or stored in a single place. Estate attorneys often take responsibility for assisting their clients with gathering all necessary information for inclusion in a will or trust. However, some information is often not included, such as digital information, business legacy information and instructions to individuals regarding the handling of certain pieces or personal property, burial instructions or the like. Information regarding the care of a pet in the event a person suddenly dies or is incapacitated may not be part of an estate or trust plan. Thus, the embodiments herein include all information necessary to completely transfer the User's interest in all matters when the User dies or becomes incapacitated (hereinafter referred to as “the Event”).

The embodiments described herein prompt the User to identify one or more people who will notify the system when the Event occurs. This person or persons is/are hereinafter referred to as “Activators” because they are responsible for activating or putting into motion the distribution of User's personal information. The system may suggest to the User to identify certain people to be Activators, namely those most likely to be in daily or regular contact with the User. It is the Activator who would likely be the first to know of the User's death or incapacitation. For instance, if the User is living with a spouse, that spouse would be a likely Activator. It should be noted that an Activator may also be a recipient of information but does not have to be, and vice versa.

Once an Activator is identified by the User, the system will attempt to contact the Activator directly using the contact information provided by the User. In the event the system is unable to contact the Activator directly, the system will send a message to the User to provide new contact information for the Activator or identify a different Activator so that the system can successfully make contact with each Activator. Once contact with the Activator has been made, the Activator will be invited to store certain contact information with the system and update such contact information in the system as needed. Updated contact information for each Activator is critical in ensuring that the system will be able to quickly and effectively contact each Activator when the Event occurs. In addition, as described in more detail below, the User will be prompted from time to time, to provide the system with any updated contact information for any identified Activator.

Identification of Recipients

Once the User has successfully uploaded information onto the system or during the upload process, the system will prompt the User to identify one or more recipients of the User's information (hereinafter referred to as “Recipient”). A Recipient is an individual who is designated by the User to receive one or more pieces of User's information after the occurrence of the Event which will be explained in detail below. In today's society, where there are numerous different family arrangements, a User may want certain people to receive certain things or information without others' knowledge. For example, a User may want certain information or things to go directly to one of the User's children but not another, or a child from a former marriage without knowledge of the User's present spouse. The User may have any number of Recipients for each piece of information, or just one Recipient to receive all of the information. The decision as to which Recipients receive any or all piece(s) of User information is made by the User with the aid of the system in the form of instructions, prompts and questions.

Management of Information

Once the information has been gathered and digitally entered into the User's designated file on the computer system, the User will then be prompted at particular time intervals to update or add such information as needed or relevant. For example, the system may prompt the User to confirm or update bank account, loan, or credit card account information on an annual basis. If the User has added or closed an account, this prompt would be a reminder to update such information.

In addition, the system may prompt the User to confirm the accuracy of Activator or Recipient or other contact information. For example, if a neighbor has been identified during the date input stage as being an Activator, but the neighbor dies or becomes incapacitated, then the User should update this information, or the system will, on a periodic basis, confirm that the prior information is accurate, which will prompt the User to amend it. Also, once the contact information for each Activator and Recipient has been added, the system may periodically contact the Activators and Recipients directly to ensure that their contact information is up to date.

After the User has inputted all data and identified all Activators and Recipients, the system will require the User to link each piece of information with a choice of times after the Event it will be distributed to one or more Recipient(s). In other words, each piece of data in a User's file will be distributed to a Recipient in accordance with a timeline designed by the User described in more detail below after the occurrence of the Event. Thus, one stage of the process for the User is linking up all of the data and information with each of the Recipients. The User may elect to release any piece of data to all Recipients or to release all pieces of data to all Recipients. It may be quite simple if a spouse or child is a designated Recipient, or it may be more complicated if there are business interests, blended and/or extended families and the like.

Assignment of Release Time

Finally, the embodiments herein provide for a distribution schedule for the User to select. The distribution schedule may be selected by the User from a menu of options provided by the computer system. The distribution schedule is designed to provide the User with varying times for retrieval and distribution for each piece of the User's personal information after the Event has occurred. For example, the User may want to distribute funeral, burial, body disposition and pet care information immediately upon confirmation that the Event has occurred. However, the User may decide to have some information regarding the disposition of certain property or the distribution of personal messages, etc. released after a week or two after the occurrence of the Event. It is anticipated that the system will provide the User with options to select when information will be released, such as immediately, or at one or two weeks following the confirmation of the occurrence of the Event.

It should be noted that the system may also include a time delay from the time the first Activator notifies the System of the Event. This delay provides the User with the opportunity to stop the Activation if it is a false activation. A more detailed description of this process is set forth below.

In use

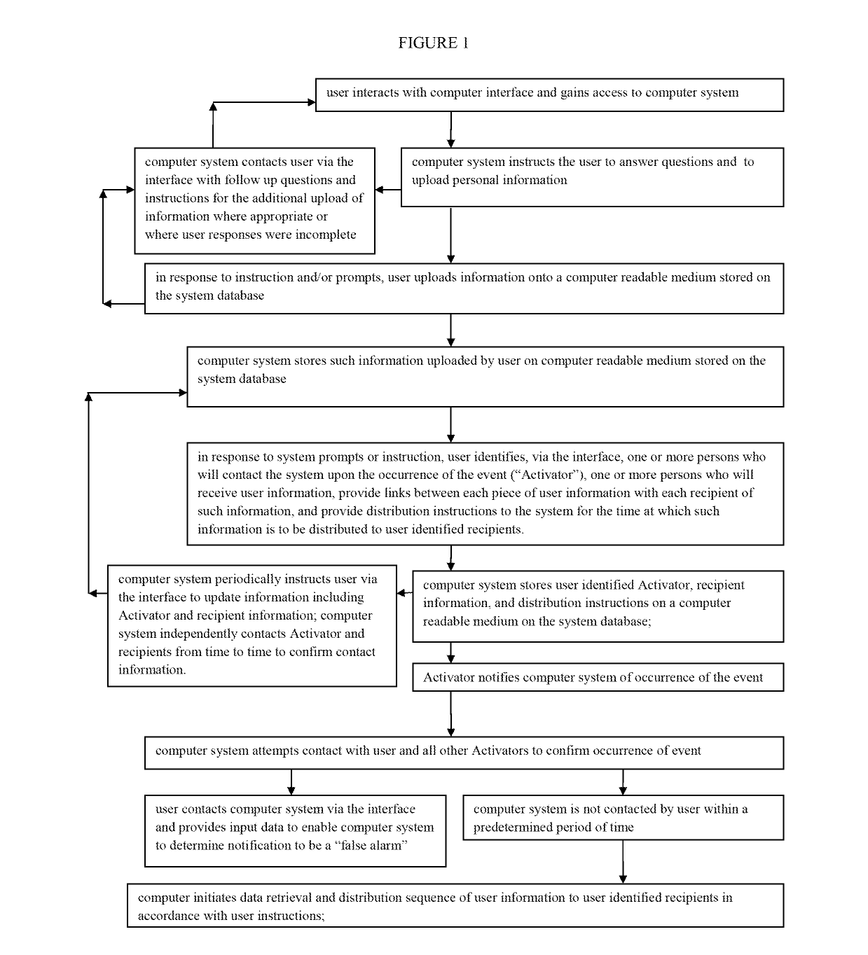

FIG. 1 is an exemplary flow diagram of the operation of a preferred embodiment system described herein. The system includes a computer interface linked to a data storage component and a computer processing component. As described above, the data that is uploaded by the User may stored remotely or in the “clouds” rather than on an individual computer memory. Alternatively, the data storage component of the system may be located directly within the User's personal computer.

In use, the User accesses the interface. As described above, the interface may be limited by way of a membership, fee payment or the like. Membership into the system enables the User to access the interface in a secure manner.

Access onto the interface may include a log-in step requiring a confidential password which protects access of User's information from disclosure to any other party, or other known techniques and technologies used to maintain security of the User's data. After the User has accessed the system via the interface, the system will prompt the User to provide information and/or answer a series of questions that have been prepared for this phase of the process. As the User answers the questions and enters information into the system, the system may follow up with another question or request for further information depending on the previous response. This may include providing the User with one or more lists of information needed, depending on how the User answered a particular question or set of questions. For example, the system may ask the User to provide information on the number, if any, of homes the User owns alone or with any other person. If the answer to that question is “none”, then the series of questions may proceed to the next topic of inquiry. However, if the answer to that questions “one” or more, than the series of questions might proceed to a further subset of questions and requests for information regarding those residences.

This line of inquiry, solicitation for information and follow up would continue until the system has received all information as initially provided by the User. For example, if the User identified a son or daughter as a Recipient, the system would prompt the User for contact information for that person. Until the User provides such information to the system, the system would continue to prompt the User via the interactive website, as well as email, phone or mail, or the like, to complete such information or remind the User that such information is missing from their file. It is anticipated that other methods of prompting, instructing or reminding a User may also be implemented in order to ensure that the accuracy and completeness of User's information.

In addition, as mentioned above, the system is designed to periodically follow up with the User, as well as User-identified Recipients and Activators, to ensure that contact information as well as other information, such as bank accounts key advisors, loans, and the like, is accurate and complete. For example, the system may send a reminder to the User after a period of time has expired since the User joined the system that would ask the User if any information needs updating or changing. This would include User contact information, as well as financial information such as opening a new credit card account, selling a house, and the like. For example, the User may have identified a neighbor as an Activator. If the neighbor has died or moved away, the User will need to identify a new Activator.

As shown in FIG. 1, the system instructs the User to identify both Activators and Recipients of User's information. The system will also instruct the User to identify what information each identified Recipient will receive. For example, a User may want one son or daughter to be the Recipient of all financial information, while releasing all information regarding burial or funeral information to another son or daughter.

After the User has uploaded all necessary data, identified all Activators and Recipients, created the necessary links of timing and Recipients for each piece of data, the system will periodically contact the User to request updates to the data, Recipient and Activator contact information, as discussed above.

When the Event (either the death or the incapacitation of the User) has occurred, one or more of the User identified Activators will contact the system via the interface to notify the system of this occurrence. This will likely be done by the Activator accessing the interface and sending an electronic communication to the computer system providing information on the User's death or incapacitation.

It should be noted that once a User identifies an Activator or a Recipient, the system will contact that party (Activator or Recipient) to set up an access account for that person to enable that individual to enter the system via the interface in a confidential and protected manner. However, it should also be noted that an Activator and/or Recipient will have limited access to the system and only be able to update his or her contact information. An Activator or Recipient would not have access to any of User's information or data.

After one Activator has notified the system of the occurrence of the Event, the system, via its processor, will immediately and automatically notify the User and any other Activators to determine whether or not the Event occurred. Upon receiving this information, the system will attempt to contact the User. This may occur via an electronic communication via text message, email, or the like, or by phone, personal visit, or the like. The system will instruct the User to access the system and provide information to indicate that the Event has not occurred. This would stop the release of any User information. If the User responds to the system's inquiry in this way, then the system knows this to be a “false alarm”. This situation could occur, for example, if a neighbor thought that the User was at home and hadn't seen the User and assumed that the User was dead, when in fact the User was visiting a relative and hadn't told the neighbor. It should also be noted that the system may also contact any other Activators to confirm or deny the occurrence of the Event. Another Activator may also submit information to the system to confirm or deny that the Event has taken place. In such a situation, the system may also require confirmation from the User. However, such confirmation may not be necessary in all situations. For example, if the User has become ill or had an accident, an Activator may interface with the system to confirm on behalf of the User that the Event did not occur. The ability of the User to empower an Activator with Event denial authority may be an option that the User may select.

Once a communication has been sent to the User and the User does not respond within a predetermined period of time, the system will seek confirmation of the occurrence of the Event from other Activators. If all other Activators confirm occurrence of the Event, the system will initiate release of the User's information in accordance with the User's preselected plan. If there is some discrepancy as to the occurrence of the Event, the system will initiate an investigation to confirm or deny the Event happening. If the Event did not happen, no User data will be distributed.

It should be noted that, the release of each piece of the User's information may occur at one of a few selected times, but the User may also elect to release all information upon initial Activation.

After the Activation and release of information has occurred, the information will be permanently deleted from the system after the expiration of a certain period of time. This time may depend on the type of account the User has purchased, the needs of the system, any legal obligations, and the like.

It should be further noted that while the description above has focused on a single User, the embodiments described herein anticipate other situations. For example, one situation would involve a couple where there would be potentially three accounts: one for each User and a joint User account. In such a situation, each member of the couple would designate those Activators and Recipients as described above with regard to individually owned property and other matters, and the couple would create a joint User account and determine together how jointly owned property is to be disposed of or determine how matters pertaining to them jointly should be handled.

It will be appreciated that the used herein, the singular forms “a,” “an,” and “the” include plural references unless the context clearly dictates otherwise. Thus, for example, the term “a recipient” or “an Activator” is intended to include both the singular and plural forms of these terms unless specifically stated otherwise.

Although particular embodiments have been described, it should be recognized that these embodiments are merely illustrative of the principles of the present invention. Those of ordinary skill in the art will appreciate that the embodiments described, and/or methods of making the embodiments of the present invention may be constructed and implemented in other ways. Accordingly, the description herein should not be read as limiting the present invention, as other embodiments may also fall within the scope of the present invention.

1. A method of uploading, storing, and distributing information comprising the steps of:
providing a computer interface, for a user to upload information onto a computer readable medium;
providing a link between the computer interface and a data storage system, the data storage system housing the user's uploaded information stored on computer readable medium;
providing a processing device that executes instructions to the user to identify a person, who will upload information via the computer interface upon the occurrence of an event;
providing a processing device that executes instructions to the user to identify a recipient of user's uploaded information upon the occurrence of the event;
providing a processing device that executes instructions to the user to select a time period for the retrieval and distribution of user's information;
enabling the user identified person to interact with the computer interface, to provide notice to the processing device that the event has occurred; and
enabling the processing device to retrieve and distribute user's information to user identified recipients in accordance with the time period preselected by the user.

2. The method of claim 1 wherein the computer interface is an interactive website.

3. The method of claim 1 wherein access to the computer interface is obtained by the payment of a fee.

4. The method of claim 1 wherein access to user information via the interactive website is password protected.

5. The method of claim l wherein user's personal information may include but not be limited to financial, banking, savings, legal information, contact information, trust accounts, investment accounts, pet information, funeral information and instructions , burial and instructions relating to the disposition of the user's body; religious and other affiliations, identification and instructions on the disposition of real and personal property, identification and disposition of personal access to other websites, business information, copies of certain photographs and documents, personal messages to be sent following the event, and the identification or the existence of any wills, trusts and other estate wishes.

6. The method of claim 1 wherein processing device instructions to user may include a series of prompts, questions or lists.

7. The method of claim 1 further comprising the step of the processing device generating a notice to the user via electronic mail, of any outstanding incomplete responses to processing device instructions.

8. The method of claim 1 wherein the event is the death or incapacitation of the user.

9. The method of claim 1 further comprising the step of providing a processing device that attempts to communicate with the user when the user identified person interacts with the computer interface, to provide notice to the processing device that the event has occurred.

10. The method of claim 9 wherein communication to the user is in the form of an electronic message.

11. The method of claim 9 wherein the number of user identified persons is greater than one.

12. The method of claim 11 further comprising the step of providing a processing device that attempts to communicate with all other user identified persons when one user identified person interacts with the computer interface, to provide notice to the processing device that the event has occurred.

13. The method of claim 1 wherein at least one of the questions posed by the computer system varies in response to the information provided by the user.

14. A system for of uploading, storing and distributing information comprising:
an interface that enables a user to upload information onto a computer readable medium;
a database to store user uploaded information;
a computing device that executes commands to:
instruct user to upload user information,
instruct user to identify at least one person to notify the computing device via the interface of the occurrence of an event,
instruct user to identify at least one recipient to receive user information upon the occurrence of the event,
instruct user to select a time period for the retrieval and distribution of user information to one or more user identified recipients upon the occurrence of the event, enable the user identified person to notify the computing device when the event has occurred, and
retrieve and distribute user information to user identified recipients in accordance with the time periods preselected by the user.

15. The system of claim 14 wherein the interface is an interactive website

16. The system of claim 14 wherein a user gains access to the interface by the payment of a fee.

17. The system of claim 14 wherein access to the interface is password protected.

18. The system of claim 14 wherein user information may include but not be limited to financial, banking, savings, legal information, contact information, trust accounts, investment accounts, pet information, funeral information and instructions , burial and instructions relating to the disposition of the user's body; religious and other affiliations, identification and instructions on the disposition of real and personal property, identification and disposition of personal access to other websites, business information, copies of certain photographs and documents, personal messages to be sent following the event, and the identification or the existence of any wills, trusts and other estate wishes.

19. The system of claim 14 wherein the database is located remotely from the interface.

20. The system of claim 11 wherein the event is the death or incapacitation of the user.
